(19) United States
(12) Patent Application Publication
(10) Pub. No.: US 2006/0209056 A1
(43) Pub. Date: Sep. 21, 2006

(54) Display device with multi-level drive

(76) Inventors: Thomas E. Willis, Mountain View, CA (US); Samson X. Huang, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,105

(22) Filed: Dec. 30, 2004

(51) Int. Cl. G09G 5/00

(52) U.S. Cl. 345/204

(57) ABSTRACT

In some embodiments, a drive circuit may be coupled to a pixel element, wherein the drive circuit is configured to provide at least three different signal levels to the pixel element. Other embodiments are disclosed and claimed.

The invention relates to display systems and more particularly to display devices and methods of operating display devices.

### BACKGROUND AND RELATED ART

A spatial light modulator (SLM) is a device which imparts information onto a light beam. For example, SLMs include liquid crystal devices (LCD—reflective and transmissive) and micro-electronic mirror systems (MEMS). SLMs are useful as part of display devices and other applications. One known type of display device utilizing an SLM is an LCD having a liquid crystal (LC) material which is driven by electronics located under each pixel. There are many known pixel architectures for these devices, each of which utilizes different structures and techniques to drive the LC material. For example, an analog pixel architecture might represent the color value of the pixel with a voltage that is stored on a capacitor under the pixel. This voltage can then directly drive the LC material to produce different levels of intensity on the optical output.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a block diagram of a display device in accordance with some embodiments of the present invention.

FIG. 2 is a block diagram of another display device in accordance with some embodiments of the present invention.

FIG. 3 is a block diagram of another display device in accordance with some embodiments of the present invention.

FIG. 4 is a schematic diagram of another display device in accordance with some embodiments of the present invention.

FIG. 5 is a block diagram of another display device in accordance with some embodiments of the present invention.

FIG. 6 is a schematic diagram of another display device in accordance with some embodiments of the present invention.

FIG. 7 is a block diagram of a method of operation in accordance with some embodiments of the present invention.

FIG. 8 is a timing diagram in accordance with some embodiments of the present invention.

FIG. 9 is another timing diagram in accordance with some embodiments of the present invention.

FIG. 10 is a block diagram of a display system in accordance with some embodiments of the present invention.

FIG. 11 is a block diagram of another display system in accordance with some embodiments of the present invention.

FIG. 12 is a block diagram of another display system in accordance with some embodiments of the present invention.

FIG. 13 is a block diagram of another display system in accordance with some embodiments of the present invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

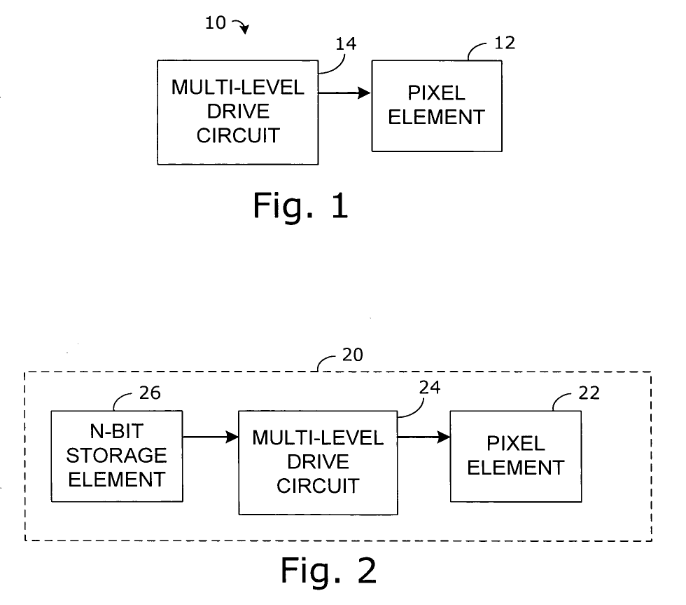

With reference to FIG. 1, a display device 10 includes a pixel element 12 and a multi-level drive circuit 14 coupled to the pixel element 12. For example, the multi-level drive circuit 14 may be configured to provide at least three different signal levels to the pixel element 12. For example, the multi-level drive circuit 14 may include either a digital-to-analog converter (DAC) circuit or an analog multiplexer (MUX) circuit, among other suitable circuit configurations. For example, the pixel element may include a pixel electrode of a liquid crystal display device or a micro-mirror display device.

In some embodiments, a display may include an array of pixel elements 12 and the multi-level drive circuit 14 may be physically co-located with the array of pixel elements 12 on the same integrated circuit die. In some embodiments, a local multi-level drive circuit 14 may be provided for each pixel element 12 in the array. For example, each multi-level drive circuit 14 and pixel element 12 may be physically co-located in a same pixel cell on the same integrated circuit die. Alternatively, some or all of the drive circuits 14 may be provided on one or more circuits not integrated on the same die with the pixel elements 12, but electrically coupled thereto.

For example, the display device 10 may be part of a silicon light modulator (SLM) utilizing a liquid crystal material (LC) that is driven by electronics located under each pixel. There are many other pixel architectures for SLMs, each of which have implications on how the pixel element is driven. For example, a digital pixel might use pulse-width modulation (PWM) to switch the pixel between black and white at a duty cycle that represents the desired gray level.

With PWM digital drive, the device represents the gray level by modulation over a base period of time T_{M}. For example, in some video systems, this base time might be a single video frame. The PWM may operate by slicing T_{M} into N discrete quanta each of duration T_{Q}. For example, the quanta may represent a minimum pulse duration that the device can generate or effectively utilize. In general, more quanta may be provide better control over the duty cycle, and thus the response of the system.

However, increasing the number N of quanta may require decreasing the duration T_{Q}, which may consequently increase the operating frequency and power consumption of the SLM device. Advantageously, some embodiments of the invention may provide additional quanta (effectively) without increasing the operating frequency of the device, by using a multi-level drive circuit to drive the pixel elements. For example, instead of driving the pixel element at one of two states (e.g. corresponding to black and white), some embodiments of the invention may drive the pixel element at one of three or more states.

With reference to FIG. 2, a pixel cell 20 includes a pixel element 22 and a multi-level drive circuit 24 coupled to the pixel element 22. For example, the multi-level drive circuit 24 may be configured to provide at least three different signal levels to the pixel element 22. For example, the multi-level drive circuit 24 may include either a digital-to-analog converter (DAC) circuit or an analog multiplexer (MUX) circuit, among other suitable circuit configurations. The pixel cell 20 further includes an n-bit storage element 26, where n is 2 or more. The storage element 26 may be coupled to the drive circuit 24. For example, the drive circuit 24 may be configured to drive the pixel element 22 with one of the at least three different signal levels in accordance with a value stored in the n-bit storage element 26.

For example, the multi-level drive circuit 24 may convert the output from the n-bit storage element into a corresponding voltage level for the pixel element 22. Advantageously, some embodiments of the invention may provide additional control over the gray level of a display device without increasing the operating frequency of the device. Of course, some embodiments of the invention may alternatively provide the same amount of gray level control as conventional devices with an advantageously lower operating frequency and/or power level.

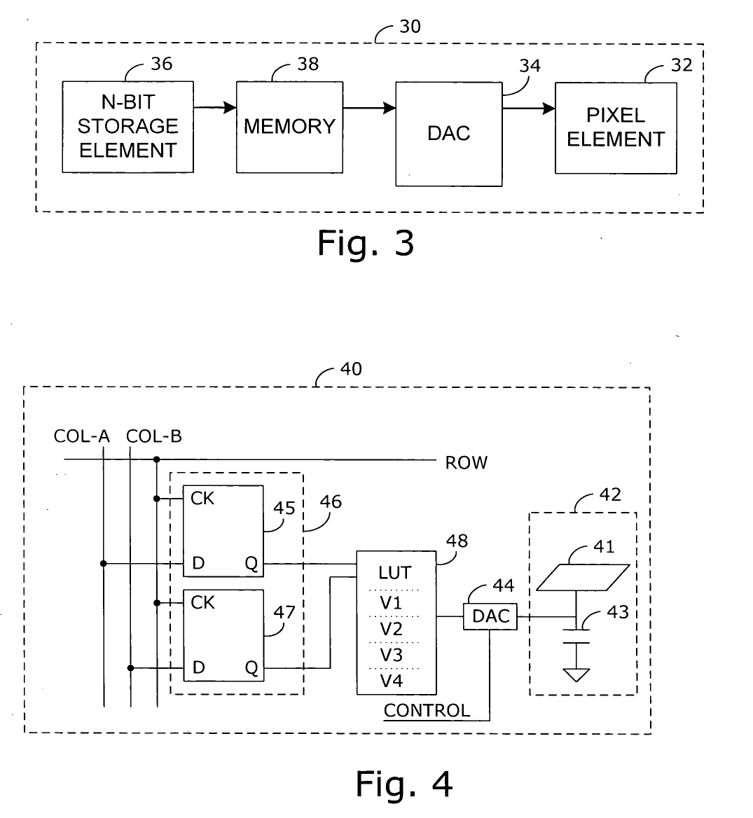

With reference to FIG. 3, a pixel cell 30 includes a pixel element 32 and a digital-to-analog converter (DAC) circuit 34 coupled to the pixel element 32. For example, the DAC circuit 34 may be configured to provide at least three different signal levels to the pixel element 32. The pixel cell 30 further includes an n-bit storage element 36, where n is 2 or more. A memory 38 may be coupled between the storage element 36 and the DAC circuit 34. For example, the memory 38 may include a look-up table configured to store values corresponding to the at least three different signal levels.

For example, a value stored by the n-bit storage element 36 may be used as an address pointer for the memory 38 (e.g. to index the look-up table). The memory 38 may store values corresponding to desired signal levels (e.g. output voltages) stored in memory locations. When the address indicated by the value stored by the n-bit storage element 36 is applied to the memory 38, the corresponding signal level value is read out from the memory 38 and applied to the DAC circuit 34. The DAC circuit 34 converts the digital value to an analog signal level and drives the pixel element 32 with the analog signal level.

The memory 38 may be volatile or non-volatile. For example, the memory 38 may be loaded with appropriate values each time the memory 38 is powered on. Alternatively, the memory 38 may be a read only memory which is manufactured with preset values. Alternatively, the memory 38 may be an electrically programmable non-volatile memory, such as a flash memory, which may be programmed with application dependent signal level values. Some memory configurations may include an address register, which may take the place of the n-bit storage element in some embodiments.

With reference to FIG. 4, a pixel cell 40 includes a pixel element 42 and a digital-to-analog converter (DAC) circuit 44 coupled to the pixel element 42. For example, the DAC circuit 44 may be configured to provide at least three different signal levels to the pixel element 42. The pixel cell 40 further includes an n-bit storage element 46, where n is 2 or more. A look-up table 48 is coupled between the storage element 46 and the DAC circuit 44. For example, the look-up table 48 is configured to store values V1, V2, V3, and V4 corresponding to four different voltage levels, and the DAC circuit 44 is configured to drive the pixel element in accordance with the values stored in the look-up table 48.

For example, the pixel element may include a pixel electrode 41 coupled to one side of a charge storage element 43. The other side of the charge storage element 43 may be grounded. The charge storage element 43 (e.g. a capacitor) holds a charge representing a gray scale value of the pixel. The DAC circuit 44 receives a control signal which controls access to the capacitor 43. Alternatively, a separate enable switch (e.g. a transistor) may be connected between the DAC circuit 44 and the pixel element 42.

For example, the n-bit storage element 46 includes two D flip-flops 45 and 47, providing a 2-bit storage element. For example, data values (e.g. 1 or 0) on columns lines COL-A and COL-B are stored by the D flip-flops 45 and 47 when the row line ROW is enabled to write the corresponding row of data. The Q outputs of the flip-flops 45 and 47 are connected to the look-up table 48 as an index to the table values. For example, when the binary index value is 00, the digital value corresponding to V1 is provided to the DAC circuit 34. For an index value of 01, V2 is provided, and so on for V3 and V4.

When the control signal CONTROL is active, the output of the DAC circuit 34 is applied to the capacitor 43, for as long as the control signal is active. For example, the control signal may be derived from one or more of the state of a write line, a bit line, a ramp value, and/or a pulse width modulation signal. For example, the control signal may become active at the beginning of the refresh cycle and may stay active until a digital ramp value equals a pixel data value for the corresponding pixel cell, thus transferring an appropriate amount of charge to the capacitor 43 in accordance with the stored voltage signal level. Those skilled in the art will appreciate that the pixel cell, charge storage element, enable switch, and/or electrode may take other forms depending on the particular display technology.

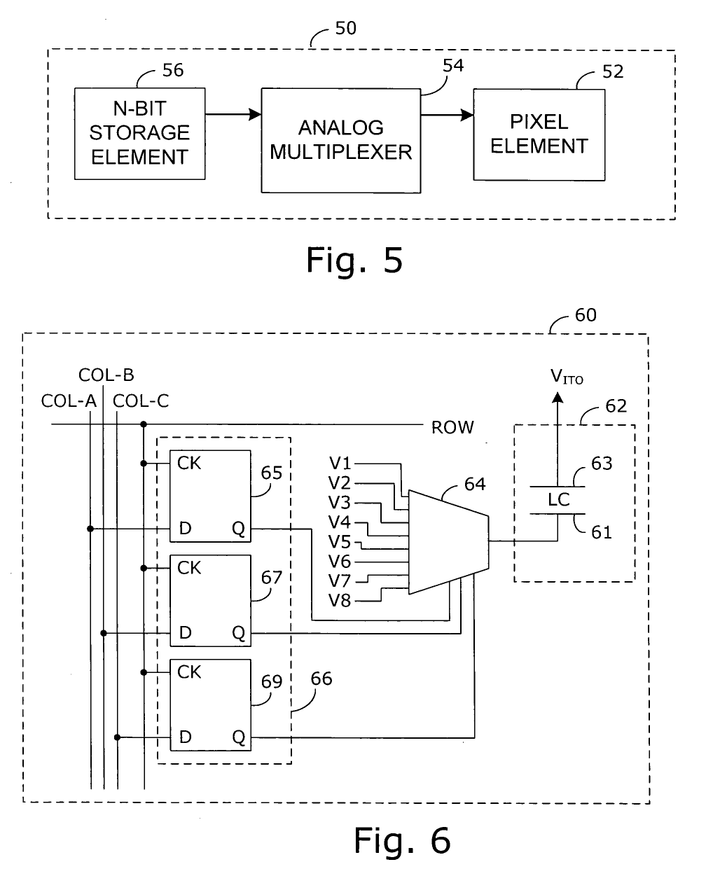

With reference to FIG. 5, a pixel cell 50 includes a pixel element 52 and an analog multiplexer (MUX) circuit 54 coupled to the pixel element 52. For example, the analog MUX circuit 54 may be configured to provide at least three different signal levels to the pixel element 52. The pixel cell 50 further includes an n-bit storage element 56, where n is 2 or more. The storage element 56 may be coupled to the analog MUX circuit 54. For example, the analog MUX circuit 54 may be configured to drive the pixel element 22 with one of the at least three different signal levels in accordance with a value stored in the n-bit storage element 56.

With reference to FIG. 6, a pixel cell 60 includes a pixel element 62 and an analog MUX circuit 64 coupled to the pixel element 62. For example, the analog MUX circuit 64 may be configured to provide eight different signal levels (V1 through V8) to the pixel element 62. The pixel cell 60 further includes an n-bit storage element 46, where n is 3. For example, the analog MUX circuit 64 is configured to select one of the eight voltages to drive the pixel element 62 in accordance with the value stored in the 3-bit storage element 66.

For example, the pixel element may include a pixel electrode 41 coupled to an output of the analog MUX circuit 64. The pixel element may further include a common electrode 63 with liquid crystal material disposed between the pixel electrode 61 and the common electrode 63. For example, the common electrode 63 may be common to all pixel elements in a display and may be made from indium titanium-oxide (ITO). A bias voltage (V_{ITO}) is applied to the common electrode 63 to provide the proper bias to the LC cell and to preserve DC balance. In some embodiments, the analog MUX circuit 64 may receive a control signal (not shown) which controls access to the pixel electrode 61. Alternatively, a separate enable switch (e.g. a transistor) may be connected between the analog MUX circuit 64 and the pixel element 62.

For example, the n-bit storage element 66 includes three D flip-flops 65, 67 and 69, providing a 3-bit storage element. The ROW signal is provided to respective clock inputs CK of the D flip-flops 65, 67 and 69, and the COL signals are provided to respective inputs D of the D flip-flops 65, 67 and 69. For example, the D flip-flops 65, 67 and 69 may hold the current state of the PWM waveform for the pixel. For example, data values (e.g. 1 or 0) on columns lines COL-A, COL-B and COL-C are stored by the D flip-flops 65, 67 and 69 when the row line ROW is enabled to write the corresponding row of data. The Q outputs of the D flip-flops 65, 67 and 69 are connected to the analog MUX circuit 64 to select the corresponding analog output voltage. For example, when the collective binary output is 000, the digital value corresponding to V1 is provided to the pixel element 62. For a binary value of 001, V2 is provided, and so on for V3 through V8.

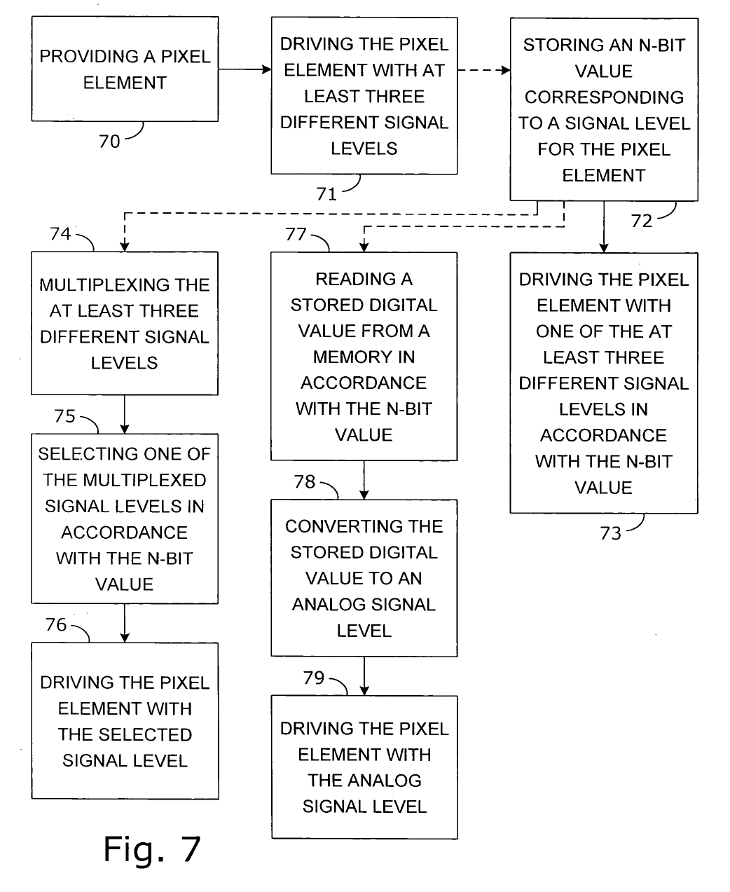

With reference to FIG. 7, some embodiments of the invention include providing a pixel element (e.g. at block 70), and driving the pixel element with at least three different signal levels (e.g. at block 71). Some embodiments may further include storing an n-bit value corresponding to a signal level for the pixel element (e.g. at block 72), and driving the pixel element with one of the at least three different signal levels in accordance with the n-bit value (e.g. at block 73).

For example, some embodiments may include multiplexing the at least three different signal levels (e.g. at block 74), selecting one of the multiplexed signal levels in accordance with the n-bit value (e.g. at block 75), and driving the pixel element with the selected signal level (e.g. at block 76).

For example, some embodiments may include reading a stored digital value from a memory in accordance with the n-bit value (e.g. at block 77). Some embodiments may further include converting the stored digital value to an analog signal level (e.g. at block 78), and driving the pixel element with the analog signal level (e.g. at block 79).

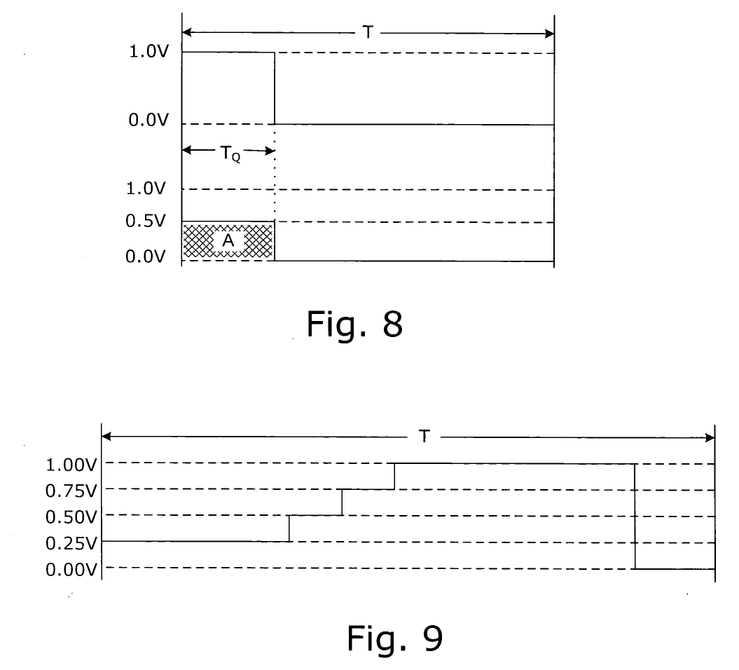

With reference to FIG. 8, a timing diagram of voltage versus time shows an example of how using multi-level signals in a PWM display system can allow for additional grayscale control. For simplicity sake, the optical response of the LC material is assumed to be linear with voltage. That is, if the pixel intensity at some voltage V is J, then the intensity at 0.5V is 0.5 J. One figure of merit for a PWM display system is the duty cycle of the smallest pulse the system can produce which represents the finest control the device provides over its grayscale.

Assume a system can produce a minimum pulse duration of T_{Q} seconds as shown in FIG. 8. In the top waveform of FIG. 8, the system is limited to driving the pixels with rail voltages, nominally 0.0V and 1.0V (e.g., conventional PWM). In the bottom waveform of FIG. 8, some embodiments of a system in accordance with the invention can drive the pixels with voltages 0.0V, 0.50V, and 1.0V. The gray scale value in a PWM system may correspond to the area A under the drive waveform. Accordingly, for a given value of T_{Q} (minimum pulse duration), the multi-level drive signal provides additional gray control. In other words, some embodiments of the invention may advantageously increase the number of quanta without decreasing the minimum pulse duration.

The control circuitry for a PWM display system may use the multi-level drive signals in any of a number of suitable drive techniques. With reference to FIG. 9, one suitable technique may involve using a fixed mapping between the drive value and the current location in the modulation time. For example, all PWM waveforms may start out driving at lower voltages and then increase. Advantageously, this technique may provide improved control over the dim regions of the tone scale where such control is relatively more important (possibly trading off with overall brightness, which may be acceptable in some applications requiring more gray control). Trade-offs with brightness may be reduced by moving to full-rail drive signals as quickly as is practical while still providing some enhanced control at the low end of the tone scale.

The example of FIG. 9 may be better suited to applications where all pixel elements in the array are driven by the same voltage. In other embodiments, with the ability to independently control the drive voltage at each pixel element, the brightness trade-off may be avoided with other control logic configured to select the drive voltages to attain the desired gray level.

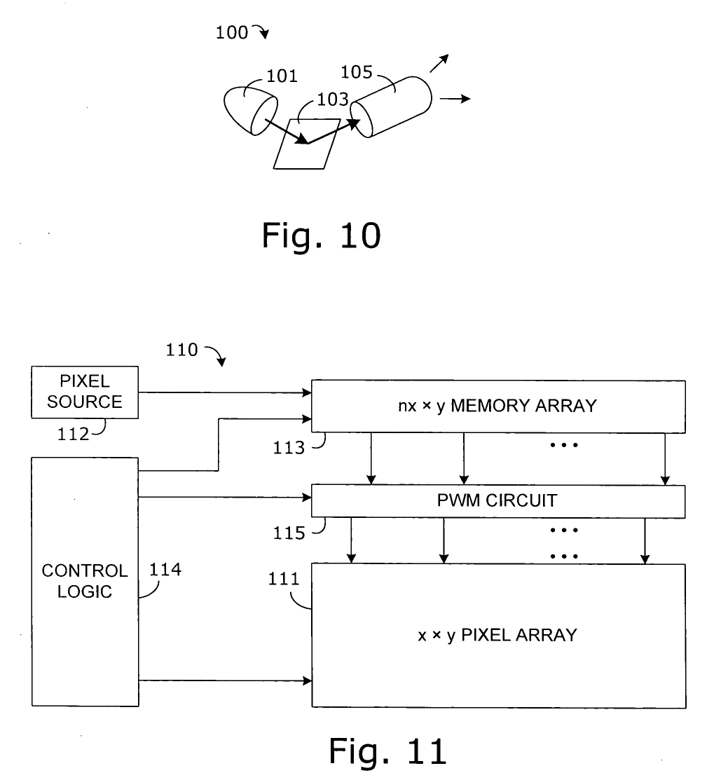

With reference to FIG. 10, a display system 100 according to some embodiments of the invention includes a light engine 101, a projection lens 105, and a spatial light modulator (SLM) 103 positioned between the light engine 101 and the projection lens 105. The SLM 103 may receive light from the light engine 101 and encode the light with image information. The projection lens 105 may receive the encoded light from the SLM 103 and project the encoded light (e.g. on a display screen). For example, the SLM 103 may include an array of pixel cells with each pixel cell including a pixel element and a drive circuit coupled to the pixel element, wherein the drive circuit is configured to provide at least three different signal levels to the pixel element. For example, the pixel cells may have any of the features described above. For example, in the system 30 the spatial light modulator may be a micro-electronic mirror device, a liquid crystal device, or another type of spatial light modulator.

With reference to FIG. 11, an SLM system 110 for operating an SLM device includes a pixel array 111 (e.g. an X by Y SLM device). A pixel source 112 provides pixel data to a memory circuit 113. For example the memory circuit 113 is an X by Y memory array of n-bit wide data. A control logic circuit 114 provides control signals to the memory circuit 113 and also to a PWM circuit 115. The PWM circuit 115 receives signals from the memory circuit 113 and provides global signals to drive the pixel array 111. In accordance with some embodiments, the pixel array 111 includes local drive circuits configured to provide at least three different signal levels to pixel elements in the pixel array 111, in accordance with the global drive signals from the PWM circuit 115.

Without limitation, the pixel source 112 may be a computer system, graphics processor, digital versatile disk (DVD) player, and/or a high definition television (HDTV) tuner. In addition, the pixel source 112 may not provide pixel data for all of the pixels in the display system. For example, the pixel source may simply provide the pixels that have changed since the last update.

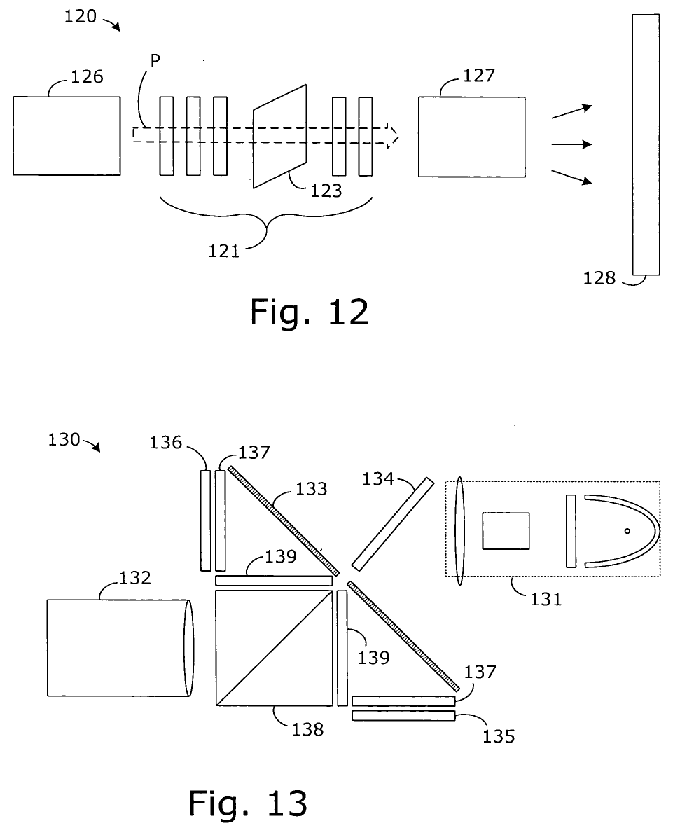

With reference to FIG. 12, a display system 120 may include one or more optical components 121 disposed along an optical path P. For example, the optical components 121 may include one or more lenses, filters, color switching components, polarizers, clean-up polarizers, and/or prisms, among other optical components which find utility in a display system. The optical components 121 may further include a spatial light modulator 123 disposed along the optical path P and configured to modulate light. In some embodiments, the system 120 further includes a drive circuit 125 coupled to or integrated with the spatial light modulator 123, wherein the drive circuit 125 is configured to provide a multi-level drive signal to the spatial light modulator 123. For example, the SLM 123 may include an array of pixels elements and the drive circuit 125 may be configured to drive the array of pixel elements with at least three different signal levels.

For example, in the system 120 the spatial light modulator 123 may be a micro-electronic mirror device, a liquid crystal device, or another type of spatial light modulator. The display system 120 may further include a light engine 126 configured to provide light along the optical path P. The light from the light engine 126 may be acted on by the various optical components 121 along the optical path P, including the spatial light modulator 123. An output beam from the optical components 121 may enter a projection lens 127 to be projected on a display screen 128 configured to display an image of the modulated light from the spatial light modulator 123. Although illustrated as substantially linear, the optical path P may bend or reflect in accordance with the physical arrangement of the components in the display system 120.

With reference to FIG. 13, a display system 130 may include a light engine 131 and a projection subsystem 132, and utilize a wire grid polarizer 133 as a polarization beam splitter. Light from the light engine 131 is directed to a red dichroic mirror 134 which reflects red light through the WGP 133 to a first LCOS panel 135 and passes blue and green light through the WGP 133 to second LCOS panel 136. The LCOS panels 135 and 136 may have associated additional optical components 137, such as filters, lenses, etc. A color switch subsystem (not shown) may switch blue and green light on the second LCOS panel 136.

In some embodiments, the system 130 further includes a first drive circuit coupled to or integrated with the first LCOS panel 135, and a second drive circuit coupled to or integrated with the second LCOS panel 136, wherein the drive circuits are respectively configured to provide multi-level drive signals to the respective LCOS panels 135 and 136. For example, the LCOS panels 135 and 136 may each include an array of pixel elements and the drive circuits may be configured to drive the array of pixel elements with at least three different signal levels.

Substantially polarized, modulated light from the first and second LCOS panels 135 and 136 is reflected by the opposite side of the WGP 133 onto respective faces of a combining prism 138. In accordance with some embodiments of the invention, and as illustrated in FIG. 13, clean-up polarizers 139 are disposed on each of the respective faces of the combining prism 138 which receive the substantially polarized, modulated light from the respective panels. Alternatively, a single clean-up polarizer may be disposed on an exit face of the combining prism 138, proximate to the entrance aperture of the projections lens 132.

Even though single or two-panel (or two PBS) display systems have been described above, according to some embodiments, more or less panels may be utilized in various embodiments of the invention. In many embodiments, single or multi-panel-based color imaging systems may be devised without departing away from the spirit of the present invention. An example of a panel is a liquid crystal on silicon (LCOS) panel, forming screen projection displays in projection display systems. Consistent with numerous embodiments of the present invention, color schemes other than a red-green-blue (RGB) format may be employed since the RGB format is simply used here for illustration purposes only.

The foregoing and other aspects of the invention are achieved individually and in combination. The invention should not be construed as requiring two or more of such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

What is claimed is:

1. An apparatus, comprising:
a pixel element; and
a drive circuit coupled to the pixel element, wherein the drive circuit is configured to provide at least three different signal levels to the pixel element.

2. The apparatus of claim 1, further comprising:
an n-bit storage element, where n is 2 or more,
wherein the drive circuit is configured to drive the pixel element with one of the at least three different signal levels in accordance with a value stored in the n-bit storage element.

3. The apparatus of claim 2, wherein the drive circuit comprises an analog multiplexer coupled between the storage element and the pixel element.

4. The apparatus of claim 2, wherein the drive circuit comprises a digital to analog converter circuit.

5. The apparatus of claim 4, wherein the digital to analog converter circuit is coupled to the storage element.

6. The apparatus of claim 4, further comprising:
a memory coupled between the storage element and the digital to analog converter.

7. The apparatus of claim 6, wherein the memory comprises a look-up table configured to store values corresponding to the at least three different signal levels.

8. A method, comprising:
providing a pixel element; and
driving the pixel element with at least three different signal levels.

9. The method of claim 8, further comprising:
storing an n-bit value corresponding to a signal level for the pixel element; and
driving the pixel element with one of the at least three different signal levels in accordance with the n-bit value.

10. The method of claim 9, further comprising:
multiplexing the at least three different signal levels;
selecting one of the multiplexed signal levels in accordance with the n-bit value; and
driving the pixel element with the selected signal level.

11. The method of claim 9, further comprising:
reading a stored digital value from a memory in accordance with the n-bit value.

12. The method of claim 11, further comprising:
converting the stored digital value to an analog signal level; and
driving the pixel element with the analog signal level.

13. A system, comprising:
a light engine;
a projection lens; and
a spatial light modulator positioned between the light engine and the projection lens, wherein the spatial light modulator includes an array of pixel cells, each pixel cell comprising:
a pixel element; and
a drive circuit coupled to the pixel element, wherein the drive circuit is configured to provide at least three different signal levels to the pixel element.

14. The system of claim 13, the pixel cell further comprising:
an n-bit storage element, where n is 2 or more,
wherein the drive circuit is configured to drive the pixel element with one of the at least three different signal levels in accordance with a value stored in the n-bit storage element.

15. The system of claim 14, wherein the drive circuit comprises an analog multiplexer coupled between the storage element and the pixel element.

16. The system of claim 14, wherein the drive circuit comprises a digital to analog converter circuit.

17. The system of claim 16, the pixel cell further comprising:
a memory coupled between the storage element and the digital to analog converter.

18. The system of claim 17, wherein the memory comprises a look-up table configured to store values corresponding to the at least three different signal levels

19. The system of claim 13, wherein the spatial light modulator comprises a micro-electronic mirror device.

20. The system of claim 13, wherein the spatial light modulator comprises a liquid crystal device.
